(19) United States
(12) Patent Application Publication
(10) Pub. No.: US 2026/0268079 A1
(43) Pub. Date: Sep. 10, 2026

(54) SYSTEMS AND METHODS FOR ENHANCING ARTIFICIAL INTELLIGENCE RELIABILITY IN NATURAL LANGUAGE GENERATION

(71) Applicant: JPMORGAN CHASE BANK, N.A., New York, NY (US)

(72) Inventors: Vahid GOLKHOU, Seattle, WA (US); Saurabh JAIN, Jersey City, NJ (US); Sailakshmi RAVINDRANATH, Short Hills, NJ (US); Loryfel NUNEZ, New York, NY (US)

(21) Appl. No.: 19/072,481

(22) Filed: Mar. 6, 2025

(51) Int. Cl. G06F 40/284

(52) U.S. Cl. CPC G06F 40/284

(57) ABSTRACT

Systems and methods for enhancing artificial intelligence reliability in natural language generation are disclosed. A method may include a LLM evaluator receiving a question from a user electronic device; prompting a LLM to generate a plurality of candidate answers to the question, wherein each candidate answer is generated in response to the question with a different set of fine-tuning parameters and comprises a plurality of tokens; generating, using an encoder model, a contextual embedding for each pair of candidate answer and its corresponding question and fine-tuning parameters; determining, using the encoder model, an entailment probability distribution, a neutral probability distribution, and a contradiction probability distribution for each candidate answer; determining, using the encoder model, a probability of contradiction for each candidate answer relative to the plurality of candidate answers; calculating a Response Reliability Index based on the probabilities of contradiction; and returning the candidate answer with a highest contextual agreement.

### BACKGROUND OF THE INVENTION

### 1. Field of the Invention

Embodiments relate to systems and methods for enhancing artificial intelligence reliability in natural language generation.

### 2. Description of the Related Art

Large Language Models (LLMs) have demonstrated outstanding capabilities in natural language generation, making them indispensable across a wide range of applications, including customer service, healthcare, education, and especially in high-stakes industries like finance. A critical obstacle to the adoption of LLMs, however, remains their propensity to hallucinate-producing responses that are plausible but factually incorrect or misleading. In highly sensitive fields such as healthcare or finance, such hallucinations can lead to outcomes that range from minor inaccuracies to serious misjudgements with significant regulatory, financial, or reputational consequences. This makes the task of ensuring LLM reliability not only a technical challenge but also a matter of industry trust.

### SUMMARY OF THE INVENTION

Systems and methods for enhancing artificial intelligence reliability in natural language generation are disclosed. In one embodiment, a method may include: (1) receiving, by a large language model (LLM) evaluation computer program, a question from a user electronic device; (2) prompting, by the LLM evaluation computer program, a LLM to generate a plurality of candidate answers to the question, wherein each candidate answer is generated in response to the question with a different set of fine-tuning parameters and comprises a plurality of tokens; (3) generating, by the LLM evaluation computer program and using an encoder model, a contextual embedding for each pair of candidate answer and its corresponding question and fine-tuning parameters; (4) determining, by the LLM evaluation computer program and using the encoder model, an entailment probability distribution, a neutral probability distribution, and a contradiction probability distribution for each candidate answer; (5) determining, by the LLM evaluation computer program and using the encoder model, a probability of contradiction for each candidate answer relative to the plurality of candidate answers; (5) calculating, by the LLM evaluation computer program, a Response Reliability Index based on the probabilities of contradiction; and (7) returning, by the LLM evaluation computer program, the candidate answer with a highest contextual agreement in response to the Response Reliability Index being above a threshold.

In one embodiment, the fine-tuning parameters comprise a maximum number of tokens in the candidate answer, a temperature value that controls a randomness of the candidate answers, a cumulative probability for the tokens in the candidate answer, a frequency penalty, and a presence penalty.

In one embodiment, a number of the plurality of candidate answers is a parameter set by a user.

In one embodiment, the encoder model generates the contextual embedding for each pair of candidate answer and its corresponding question and fine-tuning parameters with a context.

In one embodiment, the Response Reliability Index is an inverse of an average of the probabilities of contradiction.

In one embodiment, the threshold is based on post-processing analysis of recall and precision plots.

In one embodiment, the method may also include: dynamically adjusting, by the LLM evaluation computer program, the fine-tuning parameters in response to the Response Reliability Index being below the threshold.

In one embodiment, the method may also include: dynamically adjusting, by the LLM evaluation computer program, retrieval-augmented generation parameters in response to the Response Reliability Index being below the threshold, wherein the retrieval-augmented generation parameters comprise a number of chunks and a length of each of the chunks.

According to another embodiment, a method may include: (1) receiving, by a large language model (LLM) evaluation computer program, a question from a user electronic device; (2) prompting, by the LLM evaluation computer program, a LLM to generate a candidate answer to the question; (3) prompting, by the LLM evaluation computer program, the LLM for an evaluation of the candidate answer with the question, the candidate answer, and evaluation criteria; (4) receiving, by the LLM evaluation computer program, a critique score from the LLM; (5) receiving, by the LLM evaluation computer program and from the user electronic device, user feedback on the candidate answer; and (6) generating, by the LLM evaluation computer program, a consensus score based on the critique score and the user feedback.

In one embodiment, the LLM evaluation computer program prompts the LLM for the evaluation of the candidate answer with a context.

In one embodiment, the evaluation criteria comprises factual accuracy, coherence, and task-specific requirements.

In one embodiment, the user feedback is selected from inaccurate, partially accurate, and fully accurate.

In one embodiment, the user feedback is categorized into feedback categories for use case attributes.

In one embodiment, the method may also include: re-tuning, by the LLM evaluation computer program, retrieval-augmented generation parameters in response to a systematic decline in the consensus score, wherein the retrieval-augmented generation parameters comprise a number of chunks and a length of each of the chunks.

According to another embodiment, a non-transitory computer readable storage medium may include instructions stored thereon, which when read and executed by one or more computer processors, cause the one or more computer processors to perform steps comprising: receiving a question from a user electronic device; prompting a large language model (LLM) to generate a plurality of candidate answers to the question, wherein each candidate answer is generated in response to the question with a different set of fine-tuning parameters and comprises a plurality of tokens; generating, using an encoder model, a contextual embedding for each pair of candidate answer and its corresponding question and fine-tuning parameters; determining, using the encoder model, an entailment probability distribution, a neutral probability distribution, and a contradiction probability distribution for each candidate answer; determining, using the encoder model, a probability of contradiction for each candidate answer relative to the plurality of candidate answers; calculating a Response Reliability Index based on the probabilities of contradiction; and returning the candidate answer with a highest contextual agreement in response to the Response Reliability Index being above a threshold.

In one embodiment, the fine-tuning parameters comprise a maximum number of tokens in the candidate answer, a temperature value that controls a randomness of the candidate answers, a cumulative probability for the tokens in the candidate answer, a frequency penalty, and a presence penalty.

In one embodiment, the encoder model generates the contextual embedding for each pair of candidate answer and its corresponding question and fine-tuning parameters with a context.

In one embodiment, the Response Reliability Index is an inverse of an average of the probabilities of contradiction.

In one embodiment, the non-transitory computer readable storage medium may also include instructions stored thereon, which when read and executed by the one or more computer processors, cause the one or more computer processors to perform steps comprising: dynamically adjusting the fine-tuning parameters in response to the Response Reliability Index being below the threshold.

In one embodiment, the non-transitory computer readable storage medium may also include instructions stored thereon, which when read and executed by the one or more computer processors, cause the one or more computer processors to perform steps comprising: dynamically adjusting retrieval-augmented generation parameters in response to the Response Reliability Index being below the threshold, wherein the retrieval-augmented generation parameters comprise a number of chunks and a length of each of the chunks.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for enhancing artificial intelligence reliability in natural language generation according to an embodiment;

FIG. 2 illustrates a method for enhancing artificial intelligence reliability in natural language generation according to an embodiment;

FIG. 3 illustrates a method for enhancing artificial intelligence reliability in natural language generation is provided according to another embodiment;

FIG. 4 depicts an exemplary computing system for implementing aspects of the present disclosure.

### DETAILED DESCRIPTION OF PREFERRED EMBODIMENTS

Systems and methods for enhancing artificial intelligence reliability in natural language generation are disclosed.

To mitigate the risks of AI hallucinations, human annotation and feedback are often used to refine LLMs, enabling them to incorporate nuanced, domain-specific knowledge that automated training alone cannot achieve. Human reviewers, equipped with industry expertise, can identify inaccuracies and provide critical corrections, helping LLMs learn iteratively and meet the stringent standards required in regulated and sensitive sectors.

According to embodiments, LLMs may be evaluated by leveraging human knowledge and feedback. A first embodiment uses a self-assessment model, which employs a fine-tuned ROBERTa model to evaluate LLM responses. This embodiment depends on pre-existing human-labeled datasets for each specific domain, such as finance or healthcare, to fine-tune the ROBERTa model for that context. For instance, in finance, the ROBERTa model is trained on labeled data that identifies contradictions, entailment, and neutrality, allowing it to assess LLM outputs within that domain without active human involvement during evaluation.

A Response Reliability Index (RRI), which may be calculated by comparing multiple generated answers, ensures that the LLM's output aligns with the context and criteria defined in the training phase. This may be particularly valuable for scaling evaluations across large datasets or automated systems where immediate human feedback may not be feasible. Its effectiveness, however, relies on the quality of the human-labeled data used for initial training, making the role of domain experts critical in the early stages.

Another embodiment may incorporate “active human feedback” after the LLM generates a response. For example, once the LLM provides an answer, both the model and human users assess the quality of the response. The LLM may provide an initial critique score, and human feedback offers real-time evaluations based on accuracy, user experience, or domain-specific logic. This feedback is then integrated into the evaluation process, resulting in a “Consensus Score” that reflects both automated and human evaluations. This approach is useful when there is a need for human judgment in refining responses, especially in more subjective or user-focused applications. It allows the model to adapt based on real-world feedback, ensuring ongoing improvements in accuracy and relevance.

Depending on the situation and specific needs of the use case, one embodiment may prove more advantageous than the other. Both embodiments improve the accuracy and reliability of LLM outputs, but they differ in how and when human involvement is applied. The embodiments offer flexibility based on the circumstances: the self-assessment method using fine-tuned ROBERTa is effective for systematic, large-scale evaluations with domain-specific datasets, while the human-in-the-loop approach offers dynamic refinement of LLM responses based on direct user feedback.

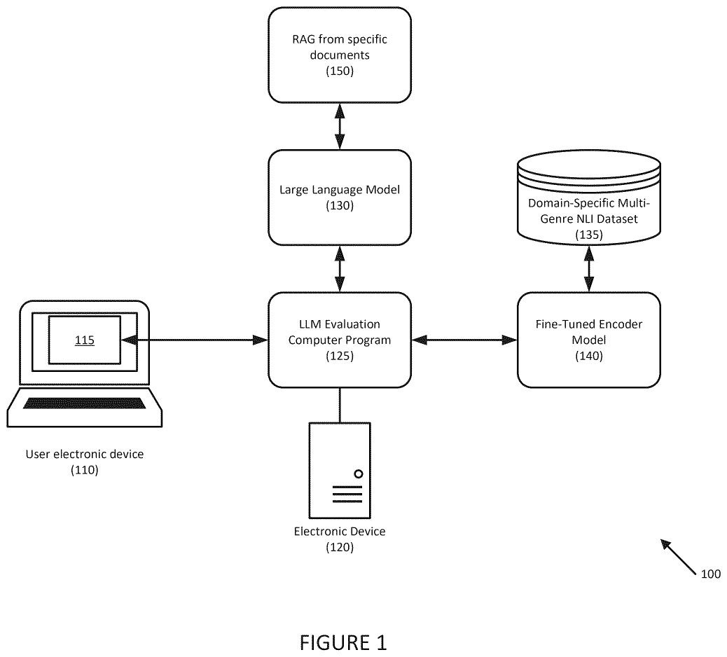

Referring to FIG. 1, a system for enhancing artificial intelligence reliability in natural language generation is provided according to an embodiment. System 100 may include user electronic device 110, which may be a computer (e.g., a workstation, a desktop, a notebook, a laptop, a tablet, etc.), a smart device (e.g., a smart phone, a smart watch, etc.), an Internet of Things (“IoT”) appliance, etc. User electronic device 110 may execute user computer program 115, such as an application, a browser, etc.

System 100 may further include electronic device 120, such as a server (e.g., physical and/or cloud-based), a computer, etc. Electronic device 120 may execute a computer program, such as LLM evaluation computer program 125.

LLM evaluation computer program 125 may evaluate LLM 130 for reliability. LLM 130 may be a generative pre-trained transformer-based model. LLM 130 may be tasked with answering a user's question. In combination with external documents (contextual information), LLM 130 may use Retrieval-Augmented Generation (RAG) architecture 150 so that LLM 130 LLM leverages relevant documents when generating its responses, making its answers more informed and contextually grounded. RAG architecture 150 may be based on current and relevant documents for a specific task, such as answering a question.

LLM evaluation computer program 125 may use a model, such as fine-tuned encoder model 140, in the evaluation. An example of such an encoder model is ROBERTa.

Fine-tuned encoder model 140 may be fine-tuned on domain-specific Multi-Genre Natural Language Inference (NLI) dataset 135 (e.g., for finance, mortgage, fees, or other key areas in finance), and evaluate the contextual agreement among generated answers from LLM 130. Domain-specific NLI dataset 135 may be curated by human subject matter experts and may enhance the ability of encoder model 140 to assess the logical relationships between text pairs within a specific context. This fine-tuning makes it particularly well-suited to determine if the LLM-generated answers are consistent with one another and with the source documents within a particular domain.

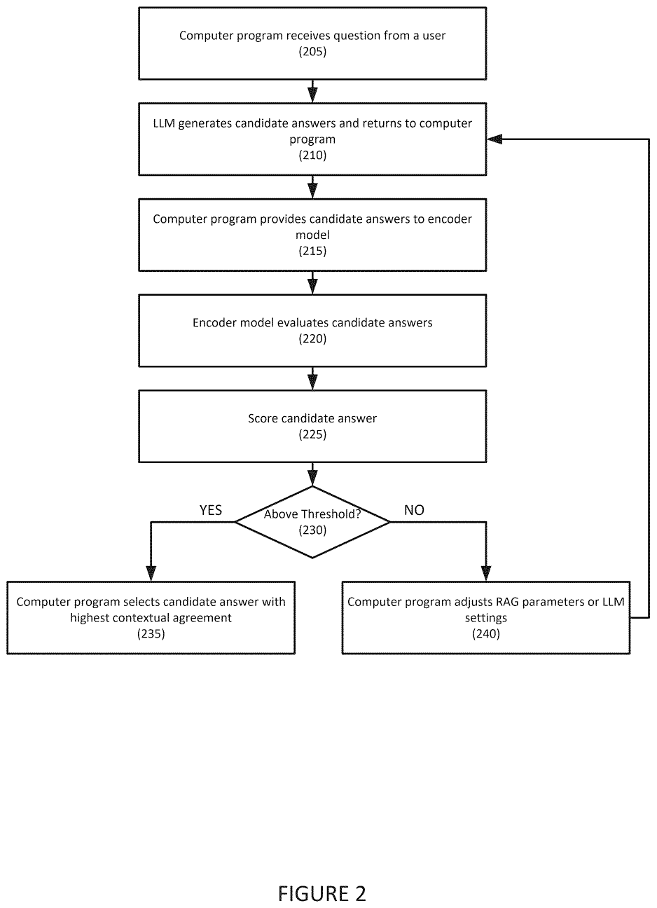

Referring to FIG. 2, a method for enhancing artificial intelligence reliability in natural language generation is provided according to an embodiment.

In step 205, a computer program, such as a LLM evaluation computer program, may receive a question from a user. For example, the question may be received from a user electronic device.

In step 210, the computer program may prompt a LLM to generate a plurality of candidate answers through varying combinations of fine-tuning parameters. The fine-tuning parameters may include, for example, a maximum number of tokens that controls the length of each generated answer, a temperature that adjusts the randomness of the LLM's predictions (e.g., lower values (closer to 0) result in more deterministic answers, while higher values (closer to 2) encourage creative and diverse responses), top percentage that regulates the diversity of the generated tokens by limiting them to a cumulative probability (e.g., setting this to 0.1 ensures only the top 10% of probable tokens are considered, which that constrains the output to the most likely terms), a frequency penalty that discourages repetitive word usage (e.g., higher values increase the LLM's tendency to introduce varied vocabulary, while lower values promote the reuse of similar words), a presence penalty that encourages or discourages the LLM to introduce new ideas and discourage repetition (e.g., a higher presence penalty promotes novel word usage in the response), etc.

The fine-tuning strategies collectively guide the LLM to generate a diverse range of answers to the same question, allowing for broader exploration of the LLM's response space. By adjusting these parameters, the system can create varied, non-repetitive, and contextually rich answers, which are then evaluated for consistency and reliability.

In one embodiment, RAG may be used with the LLM to generate answers. For example, a chunk length/size and a number of chunks may be used to generate answers during any phase of training. The values for the chunk length/size and the number of chunks may have a default value.

In one embodiment, the same question may be asked multiple times, each with a different set of parameters.

As an illustrative example, there may be a series of texts (A1, A2, . . . , An; for simplicity, let n=5). Each text represents an answer to the same question (Q), with each answer associated with a unique set of parameters. For example, param_1=[i1, j1, k1, l1, m1] corresponds to (Q, A1), and param_2= [i₂, j2, k2, l2, m2] corresponds to (Q, A2), and so forth.

Note that the value of the number of texts, n, may be selected by the user. The value of 5 is exemplary only and other values may be used as is necessary and/or desired.

In step 215, the computer program may provide the plurality of candidate answers to an encoder model.

In step 220, the encoder model may evaluate the answers. For example, the encoder model may process each premise-hypothesis pair (where the premise is the generated answer, and the hypothesis is the sample, i.e., the question with its fine-tuning parameters) through multiple transformer layers to produce a contextualized representation for each token. This allows the model to deeply understand the relationship between the premise and the hypothesis, analyzing linguistic and semantic structures specific to a context, such as mortgage regulations or fee structures.

In one embodiment, the context may be provided by the user. If the user does not provide the context, embodiments may rely on the general knowledge of the LLM, which may or may not be relevant to the question.

After generating contextualized embeddings, the encoder model may use the output of the final layer (e.g., the embedding of the special classification token [CLS]) to feed into a classification head. In one embodiment, the classification head may be a feedforward neural network with a softmax output layer, which may predict the probability distribution for all of the contextual embeddings for all of the candidate answers across three possible NLI labels: (1) entailment (i.e., the hypothesis (sample) logically follows from the premise (LLM answer), indicating a consistent response); (2) neutral (i.e., the hypothesis and premise are unrelated within the specific domain context); and (3) contradiction (i.e., the hypothesis contradicts the premise, signaling a potential inconsistency or hallucination in the LLM-generated response).

Embodiments may focus on contradiction in order with the goal of creating a “lie detector” for LLMs.

By using a human-curated dataset tailored for specific domain, the fine-tuned encoder model can offer more precise and reliable evaluations of LLM responses within these specialized domains.

In addition, the encoder model may also compare the candidate answers against each other to measure their contextual agreement. The encoder model, using its understanding of natural language and logic, assesses whether these candidate answers are mutually supportive or contradictory. This step is crucial in detecting hallucinations, as incoherent or factually inconsistent responses are indicative of potential hallucinations by the LLM.

Continuing with the illustrative example, the encoder model may process the set of texts or candidate answers generated by the LLM model, which may be packaged in the following format: set_1: {A1, [A2, A3, A4, . . . . An]}. Using the example of n=5 above, the output of the encoder model is the probability of contradiction (which is the opposite of contextual agreement), represented as follows:

$$Pr\_ 1 = Pr ( contradiction \vert A 1 , [ A 2 , A 3 , A 4 , A 5 ] )$$

The computer program may package all other possible sets (set_2, . . . ) for the encoder model and may store the corresponding probabilities, such as:

$$set\_ 1 \to Pr\_ 1$$

$$set\_ 2 \to Pr\_ 2$$

$$…$$

$$set\_n \to Pr\_n$$

In step 225, the encoder model may score the plurality of candidate answers. For example, the encoder model may return a Response Reliability Index (RRI), a score between 0 and 100 that quantifies the reliability of all of the LLM's responses. A high RRI indicates strong contextual agreement and consistency among the generated candidate answers—the inverse of contradiction-implying that the model is more reliable in providing a trustworthy candidate answer to the posed question. A low RRI suggests significant disagreement or hallucination among the candidate answers.

For example, the computer program may calculate the mean of the stored probabilities of contradiction (Pr_1, Pr_2, . . . , Pr_n) as follows:

$$( 1 / n ) {\sum }_{k = 1}^{n} ( Pr ( contradiction \vert answer , other answers ) )$$

The mean of the stored probabilities of contradiction provides a good estimate of the level of contradiction in the generated sample of responses. Each of the probabilities of contradiction measures the contradiction of a specific candidate answer against the collection of the rest of the candidate answers. Taking the mean offers an overall estimation across all combinations.

Next, the RRI score may be calculated as follows:

$$RRI = [ 1 - ( 1 / n ) {\sum }_{k = 1}^{n} ( Pr ( contradiction \vert answer , other answers ) ) ] \times 100$$

The RRI score represents the likelihood that the LLM-generated candidate answer (with temperature=0) aligns with a set of alternative LLM-generated candidate answers (with temperature/0 and fine-tuned parameters). The goal is to evaluate the contextual agreement and reliability of the LLM's output. In general, a higher RRI score indicates less hallucination by the LLM and, therefore, greater reliability.

In step 230, the computer program may compare the RRI to a threshold value, which is the minimum level of precision and recall that the model is expected to achieve. The threshold value is determined through post-processing analysis, utilizing “Recall” and “Precision” plots, as well as considering the level of confidence required by specific use cases and stakeholders. This approach is akin to standard machine learning practices for setting thresholds. For instance, if achieving 80% precision and recall is satisfactory for a particular use case, the “Recall” and “Precision” plots may be used to identify the corresponding threshold for 80%.

If the RRI exceeds the threshold value, in step 235, the candidate answer with the highest contextual agreement is selected and presented to the user.

If the RRI is below the threshold value, in step 240, the computer program may dynamically adjust the RAG parameters (e.g., the “number of chunks” and the “length of chunks”) and the LLM inference parameters (e.g., “Temperature”, “max_tokens”, “top_p”, “frequency_penalty”, and “presence_penalty”), or may fine-tune the LLM settings, and the process may return to step 210.

This process may be iterated over multiple trials to increase the likelihood of identifying a reliable and contextually accurate response.

In one embodiment, only one candidate answer is returned during each iteration, and it will be the one corresponding to the candidate answer with “temperature=0”. That candidate answer is only accepted when the calculated RRI is above the threshold.

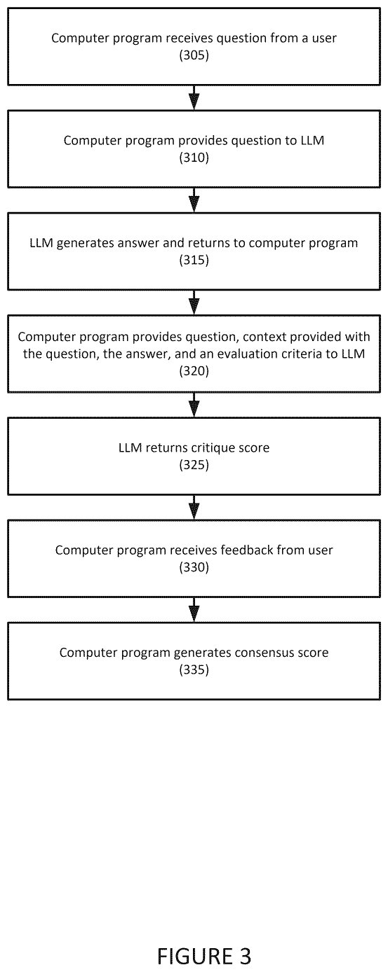

Referring to FIG. 3, a method for enhancing artificial intelligence reliability in natural language generation is provided according to another embodiment.

In step 305, a computer program, such as a LLM evaluation computer program, may receive a question from a user. For example, the question may be received from a user electronic device.

In step 310, the computer program may provide the question to an LLM.

In step 315, the LLM may generate an answer and may return the answer to the computer program.

In step 320, the computer program may provide the question, any context provided with the question, the answer, and evaluation criteria to LLM as a prompt. The evaluation criteria may include a specific set of guidelines relevant to the use case (e.g., factual accuracy, coherence, task-specific requirements, etc.).

In step 325, the LLM may return a critique score.

In step 330, the computer program may receive user feedback on the answer. For example, the user may indicate whether the answer is inaccurate (e.g., the user found the response unsatisfactory), partially accurate (e.g., the user found the response somewhat useful but incomplete), or fully accurate (e.g., the user found the response accurate and helpful).

In addition, the feedback may be categories into feedback categories that reflect specific use case attributes. For example, the feedback may be categorized under domains such as business logic (e.g., does the response align with the expected business rules or task requirements?), user experience (e.g., is the response user-friendly and understandable?), etc. Other feedback categories may be used as is necessary and/or desired.

In step 335, the computer program may generate a consensus score. For example, the computer program may combine the critique score from the LLM and the user feedback score into a consensus score. This may reconcile the LLM's self-assessment with human evaluation, leading to a more balanced and reliable measure of response quality.

This feedback-driven evaluation framework, integrating LLM self-critique with human feedback, enables a dynamic approach to improving model accuracy. By leveraging both automated scoring mechanisms and user insights, embodiments not only address potential blind spots in model responses but also ensure that the evaluations are adaptable to diverse real-world use cases.

The consensus score provides a reliable measure for determining the quality of the LLM's output, while the feedback categories guide targeted improvements in specific domains.

In one embodiment, if a systematic decline in the consensus score is observed, the LLM/RAG inference parameters may be re-tuned.

In another embodiment, the consensus score may be used to identify items where the LLM's evaluation and user input are in-sync. It may also be used to help in prioritizing items that need further investigation.

The processes of FIGS. 2 and 3 are complementary approaches that provide flexibility depending on the circumstances. For example, the process of FIG. 2 depicts a self-assessment method, which is effective for systematic, large-scale evaluations using domain-specific datasets. The process of FIG. 3 uses a human-in-the-loop, which allows for dynamic refinement of LLM responses based on direct user feedback. In streaming mode, these two processes operate independently. However, in batch mode, once sufficient user feedback is collected from the process in FIG. 3, that may be used to train or fine-tune the encoder model of FIG. 2.

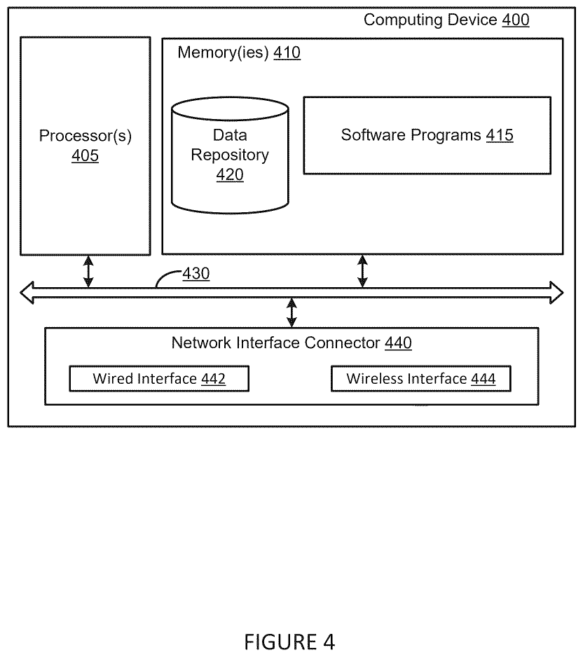

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a large language model (LLM) evaluation computer program, a question from a user electronic device;
prompting, by the LLM evaluation computer program, a LLM to generate a plurality of candidate answers to the question, wherein each candidate answer is generated in response to the question with a different set of fine-tuning parameters and comprises a plurality of tokens;
generating, by the LLM evaluation computer program and using an encoder model, a contextual embedding for each pair of candidate answer and its corresponding question and fine-tuning parameters;
determining, by the LLM evaluation computer program and using the encoder model, an entailment probability distribution, a neutral probability distribution, and a contradiction probability distribution for each candidate answer;
determining, by the LLM evaluation computer program and using the encoder model, a probability of contradiction for each candidate answer relative to the plurality of candidate answers;
calculating, by the LLM evaluation computer program, a Response Reliability Index based on the probabilities of contradiction; and
returning, by the LLM evaluation computer program, the candidate answer with a highest contextual agreement in response to the Response Reliability Index being above a threshold.

2. The method of claim 1, wherein the fine-tuning parameters comprise a maximum number of tokens in the candidate answer, a temperature value that controls a randomness of the candidate answers, a cumulative probability for the tokens in the candidate answer, a frequency penalty, and a presence penalty.

3. The method of claim 1, wherein a number of the plurality of candidate answers is a parameter set by a user.

4. The method of claim 1, wherein the encoder model generates the contextual embedding for each pair of candidate answer and its corresponding question and fine-tuning parameters with a context.

5. The method of claim 1, wherein the Response Reliability Index is an inverse of an average of the probabilities of contradiction.

6. The method of claim 1, wherein the threshold is based on post-processing analysis of recall and precision plots.

7. The method of claim 1, further comprising:
dynamically adjusting, by the LLM evaluation computer program, the fine-tuning parameters in response to the Response Reliability Index being below the threshold.

8. The method of claim 1, further comprising:
dynamically adjusting, by the LLM evaluation computer program, retrieval-augmented generation parameters in response to the Response Reliability Index being below the threshold, wherein the retrieval-augmented generation parameters comprise a number of chunks and a length of each of the chunks.

9. A method, comprising:
receiving, by a large language model (LLM) evaluation computer program, a question from a user electronic device;
prompting, by the LLM evaluation computer program, a LLM to generate a candidate answer to the question;
prompting, by the LLM evaluation computer program, the LLM for an evaluation of the candidate answer with the question, the candidate answer, and evaluation criteria;
receiving, by the LLM evaluation computer program, a critique score from the LLM;
receiving, by the LLM evaluation computer program and from the user electronic device, user feedback on the candidate answer; and
generating, by the LLM evaluation computer program, a consensus score based on the critique score and the user feedback.

10. The method of claim 9, wherein the LLM evaluation computer program prompts the LLM for the evaluation of the candidate answer with a context.

11. The method of claim 9, wherein the evaluation criteria comprises factual accuracy, coherence, and task-specific requirements.

12. The method of claim 9, wherein the user feedback is selected from inaccurate, partially accurate, and fully accurate.

13. The method of claim 9, wherein the user feedback is categorized into feedback categories for use case attributes.

14. The method of claim 9, further comprising:
re-tuning, by the LLM evaluation computer program, retrieval-augmented generation parameters in response to a systematic decline in the consensus score, wherein the retrieval-augmented generation parameters comprise a number of chunks and a length of each of the chunks.

15. A non-transitory computer readable storage medium, including instructions stored thereon, which when read and executed by one or more computer processors, cause the one or more computer processors to perform steps comprising:
receiving a question from a user electronic device;
prompting a large language model (LLM) to generate a plurality of candidate answers to the question, wherein each candidate answer is generated in response to the question with a different set of fine-tuning parameters and comprises a plurality of tokens;
generating, using an encoder model, a contextual embedding for each pair of candidate answer and its corresponding question and fine-tuning parameters;
determining, using the encoder model, an entailment probability distribution, a neutral probability distribution, and a contradiction probability distribution for each candidate answer;
determining, using the encoder model, a probability of contradiction for each candidate answer relative to the plurality of candidate answers;
calculating a Response Reliability Index based on the probabilities of contradiction; and
returning the candidate answer with a highest contextual agreement in response to the Response Reliability Index being above a threshold.

16. The non-transitory computer readable storage medium of claim 15, wherein the fine-tuning parameters comprise a maximum number of tokens in the candidate answer, a temperature value that controls a randomness of the candidate answers, a cumulative probability for the tokens in the candidate answer, a frequency penalty, and a presence penalty.

17. The non-transitory computer readable storage medium of claim 15, wherein the encoder model generates the contextual embedding for each pair of candidate answer and its corresponding question and fine-tuning parameters with a context.

18. The non-transitory computer readable storage medium of claim 15, wherein the Response Reliability Index is an inverse of an average of the probabilities of contradiction.

19. The non-transitory computer readable storage medium of claim 15, further including instructions stored thereon, which when read and executed by the one or more computer processors, cause the one or more computer processors to perform steps comprising:
dynamically adjusting the fine-tuning parameters in response to the Response Reliability Index being below the threshold.

20. The non-transitory computer readable storage medium of claim 15, further including instructions stored thereon, which when read and executed by the one or more computer processors, cause the one or more computer processors to perform steps comprising:
dynamically adjusting retrieval-augmented generation parameters in response to the Response Reliability Index being below the threshold, wherein the retrieval-augmented generation parameters comprise a number of chunks and a length of each of the chunks.
